(19) United States
(12) Patent Application Publication
(10) Pub. No.: US 2025/0065980 A1
(43) Pub. Date: Feb. 27, 2025

(54) PEDAL-ASSISTED BICYCLE AND METHOD FOR CONTROLLING A PEDAL-ASSISTED BICYCLE

(71) Applicant: ZEHUS S.p.A., Milano (IT)

(72) Inventors: Giovanni ALLI, Milano (IT); Davide FORTE, Milano (IT); Pasquale FORTE, Milano (IT); Paolo LISANTI, Milano (IT)

(21) Appl. No.: 18/723,258

(22) PCT Filed: Dec. 19, 2022
(86) PCT No.: PCT/IB2022/062445

§ 371 Date: Jun. 21, 2024

(30) Foreign Application Priority Data
Dec. 23, 2021 (IT) 102021000032516

(51) Int. Cl. B62M 6/50; B62J 43/13; B62J 43/28; B62J 45/411; B62J 45/412; B62J 45/413; B62M 6/55; B62M 6/60

(52) U.S. Cl. CPC B62M 6/50; B62J 43/13; B62J 43/28; B62J 45/411; B62J 45/412; B62J 45/413; B62M 6/55; B62M 6/60

(57) ABSTRACT

A pedal-assisted bicycle comprises a traction system provided with a battery pack, a central electric motor, an electrical device operating as an electric generator and a control unit. The control unit is configured to receive a plurality of first input signals representative of an operating condition of the bicycle and to receive a second input signal representative of the state of charge of the battery pack. The control unit is configured to identify the operating condition of the bicycle as a function of the first input signals and to emit, as a function of the second input signal and the identified operating condition, a driving signal structured so as to drive the electrical device and the central electric motor so that the state of charge follows a defined reference state of charge.

The present invention relates to a pedal-assisted bicycle and a method for controlling a pedal-assisted bicycle.

In recent years, parallel to the growing popularity of the concepts of sustainable mobility and the continuous development of increasingly high-performing electric cars, there has been an exponential growth of what are commonly known as e-bikes, i.e., bicycles equipped with an electric propulsion system capable of assisting the cyclist while pedalling.

Such bicycles have found fertile ground both in urban applications, partly replacing mopeds, and in more extreme applications, allowing the occasional enthusiast to engage in climbs along routes that, without the aid of electric propulsion, would have been beyond their reach.

In recent years, companies in the field have therefore worked the most on aspects related to the size of the actuation, to be minimized so as to make the system adaptable even to “traditional” frames, and the battery life, increased using an electric hub motor operating as both an actuator and as a generator.

With reference to this last aspect, if for “mountain bike” applications the problem related to battery life is to be considered in some way subordinate, or in any case constrained, to the need for a significant servo contribution from the motor, in city applications more than a real servo is necessary, indeed a facilitation of the cyclist in the most demanding sections is necessary, which has allowed to consider the maintenance of the battery state of charge as primary.

Precisely in relation to such developments, the Applicant has recently developed a system capable of controlling the electric hub motor so as to maintain the battery state of charge around a predetermined value, without there ever being the need (or the possibility) to recharge it through the grid.

Such a system has been described in International Patent Application No. WO2018/130982 and expressly refers to the use of an electric hub motor.

This choice is advantageous at high speeds while, at low speeds, it is only advantageous for transmission ratios less than 1. In fact, the choice to use an electric hub motor is not the optimal choice in terms of efficiency at low speeds and for transmission ratios greater than 1.

Therefore, the object of the present invention is to provide a pedal-assisted bicycle and a related method for controlling it optimally under all conditions of use.

Such an object is achieved by a pedal-assisted bicycle and a method for controlling a pedal-assisted bicycle having the technical features of one or more of the following claims. The dependent claims, included here for reference, correspond to possible embodiments of the invention.

In accordance with a first aspect, the present invention relates to a pedal-assisted bicycle comprising a frame, at least two wheels each provided with a relative hub, a pedal assembly, a transmission operatively interposed between the pedal assembly and one of the wheels. A bicycle traction system comprises at least one battery pack, a central electric motor, an electrical device configured to operate as an electric generator and a control unit configured to drive the electrical device and the central electric motor and to manage the charge level of said battery pack. The central electric motor is directly connected to the pedal assembly to provide a torque to the pedal assembly itself and is operatively connected to the battery pack to be powered by the battery pack itself. The electrical device is arranged at the hub of a wheel and is operatively connected to the battery pack to transfer current to the battery pack itself. The control unit is configured to receive a plurality of first input signals representative of an operating condition of the bicycle selectively variable between a servo operating condition and a charging operating condition. The control unit is configured to receive a second input signal representative of the state of charge of the battery pack. The control unit is configured to identify the operating condition of the bicycle as a function of the first input signals and to emit, as a function of the second input signal and the identified operating condition, a driving signal structured to drive the electrical device operating as an electric generator so as to increase the charge level of the battery pack.

In accordance with a first aspect, the present invention relates to a method for controlling a pedal-assisted bicycle comprising detecting one or more quantities representative of a bicycle operating condition, in which said operating condition is selectively variable between a servo operating condition and a charging operating condition, detecting a value representative of the state of charge of the battery pack, identifying the operating condition of the bicycle and driving the electrical device as a function of the identified operating condition and the state of charge of the battery pack so as to increase the charge level of the battery pack.

In accordance with a further aspect, the present invention relates to a pedal-assisted bicycle comprising a frame, at least two wheels each provided with a relative hub, a pedal assembly, a transmission operatively interposed between the pedal assembly and one of the wheels. A bicycle traction system comprises at least one battery pack, a central electric motor, an electric hub motor, a control unit configured to drive the electric hub motor and the central electric motor. The central electric motor is directly connected to the pedal assembly to provide a torque to the pedal assembly itself and is operatively connected to the battery pack to be powered by the battery pack itself. The electric hub motor is arranged at the hub of a wheel and is operatively connected to the battery pack to be powered by the battery pack itself. The control unit is configured to receive a plurality of first input signals representative of an operating condition of the bicycle selectively variable between a servo operating condition and a charging operating condition. The control unit is configured to identify the operating condition of the bicycle as a function of the first input signals and, in the servo operating condition, emit a driving signal structured to drive the electric hub motor and the central electric motor following a maximum efficiency curve obtained from an envelope of the efficiency curves of the electric hub motor and the central electric motor according to the linear speed of the bicycle and the transmission ratio of the bicycle.

In accordance with a still further aspect, the present invention relates to a method for controlling a pedal-assisted bicycle comprising detecting one or more quantities representative of an operating condition of the bicycle, in which the operating condition is selectively variable between a servo operating condition and a charging operating condition, identifying the bicycle operating condition and, in the servo operating condition, driving the electric hub motor and the central electric motor following a curve of maximum efficiency obtained from an envelope of the efficiency curves of the electric hub motor) and of the central electric motor as a function of the linear speed of the bicycle and the transmission ratio of the bicycle.

These and other features, with the related technical advantages, will become more apparent from the following exemplary, and therefore non-limiting, description of a preferred, therefore not exclusive, embodiment of a pedal-assisted bicycle and a related method for controlling it, as shown in the following figures, in which:

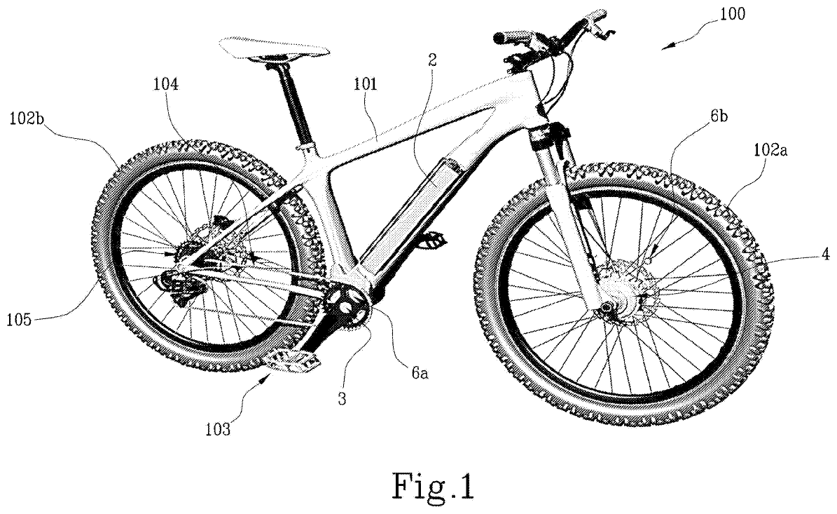

FIG. 1 schematically shows a pedal-assisted bicycle in side view;

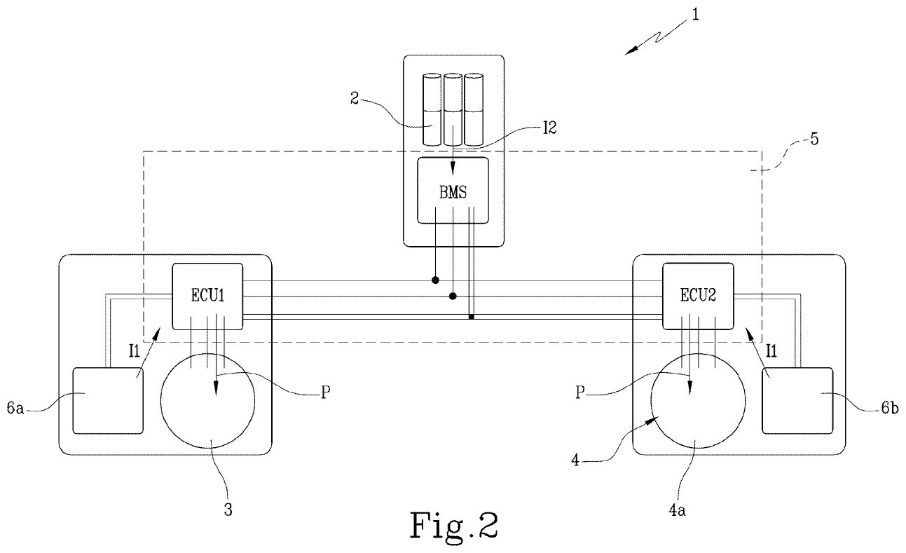

FIG. 2 shows a diagram of a traction device of the pedal-assisted bicycle of FIG. 1;

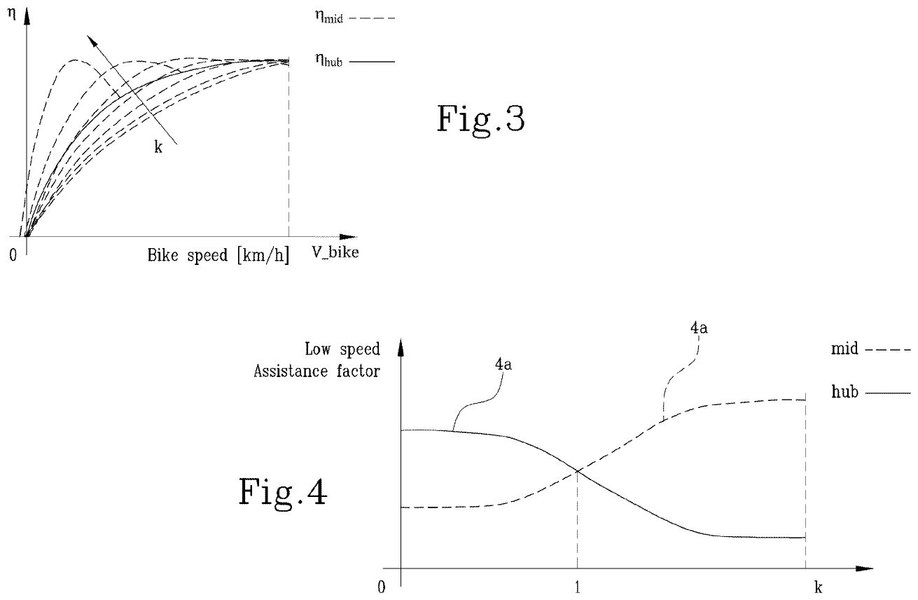

FIG. 3 shows the efficiency curves of the central electric motor and the electric hub motor as a function of the linear speed of the bicycle and its transmission ratio;

FIG. 4 shows a low speed servo coefficient of the traction system as a function of the transmission ratio;

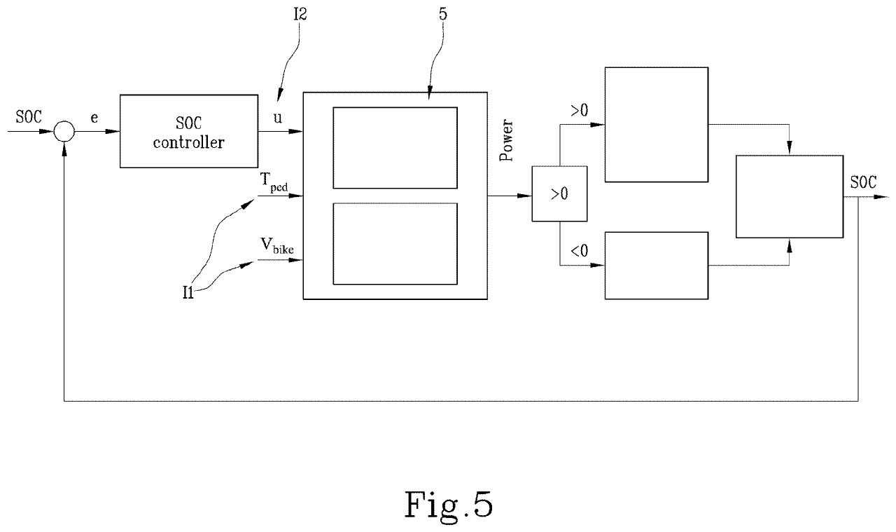

FIG. 5 shows an operating logic diagram of the traction system of FIG. 2.

With reference to FIG. 1, the number 100 indicates a pedal-assisted bicycle comprising a frame 101 on which two wheels are mounted, of which a front wheel 102a and a rear wheel 102b, each provided with a relative hub.

The pedal-assisted bicycle 100 further comprises a pedal assembly 103 and a transmission system 104 (preferably a chain) for transferring motion from the pedal assembly 103 to one of the wheels (in particular the rear wheel 102b).

A freewheel mechanism 105 is further provided, operatively interposed between the transmission system 104 and the rear wheel 102b, so as to allow the rotation thereof even in the absence of pedalling.

The pedal-assisted bicycle 100 comprises a traction system 1 comprising at least one battery pack 2, a central electric motor 3, and an electrical device 4 operating as an electric generator.

The central electric motor 3 is directly connected to the pedal assembly 103 to provide a torque to the pedal assembly itself. Furthermore, the central electric motor 3 is operatively connected to the battery pack 2 to be powered by the battery pack itself.

The electrical device 4 is arranged at the hub of one of the wheels, preferably the front wheel 102a, and is operatively connected to the battery pack 2 to transfer current to the battery pack itself.

A control unit 5 of the traction system 1 consists for example of the logic unit of several modules including a battery management system (BMS or SOC controller), a first control unit ECU1 dedicated to the central electric motor 3 and a second control unit ECU2 dedicated to the electrical device 4.

The control unit 5 is configured to drive the electrical device 4 operating as the electric generator and the central electric motor 3. Furthermore, the control unit 5 is configured to manage the charge level of the battery pack 2.

In particular, the control unit 5 is configured to receive a plurality of first input signals I1 representative of an operating condition of the bicycle selectively variable between a servo operating condition and a charging operating condition,

The expression “servo operating condition” refers to a condition in which the traction system 1 assists pedalling by providing a driving torque which is added to the torque produced by the cyclist on the pedals.

The expression “charging operating condition” refers to a condition in which the traction system 1 does not assist pedalling and therefore does not provide any driving torque. For example, these are conditions in which the bicycle is advancing downhill or at a sustained speed greater than a predefined value, or in which an external command is explicitly activated, for example by cycling backwards or by activating a remote control or the brakes of the bicycle.

The predefined value is variable as a function of the type of bicycle and the national regulations, it can be for example 25 km/h, or it can reach 45 km/h for S-Pedelec in Germany, 20 mph-about 32 km/h—for Class 1 in the USA and also 28 mph for Class 3.

Preferably the first input signals I1 comprise one or more of:
a first input signal representative of the pedal speed ω_{ped},
a first input signal representative of the torque applied to the pedal assembly T_{ped},
a first input signal representative of the linear speed of the bicycle V_{bike}.
a first input signal representative of a cyclist command (backward pedalling, remote control, brake activation).

Preferably, the traction system 1 comprises first sensor means 6a-6b operatively connected to the control unit 5 and configured to detect one or more quantities representative of the operating condition of the bicycle and to generate a respective first input signal I1. For example, the first sensor means comprise a first sensor 6a and/or a second sensor 6b. The first sensor 6a is configured to detect a representative quantity of pedal speed ω_{ped} and/or torque applied to the pedal assembly T_{ped}. The second sensor 6b is configured to detect a representative quantity of the linear speed V_{bike} of the bicycle.

The control unit 5 is configured to receive a second input signal I2 representative of the state of charge SOC of the battery pack 2 Preferably, the traction system 1 comprises second sensor means forming part of the management system BMS (or SOC controller) operatively connected to the control unit 5 and configured to detect a value representative of the state of charge SOC of the battery pack 2 and to generate the second input signal I2.

Furthermore, the control unit 5 is configured to identify the operating condition of the bicycle as a function of the first input signals I1. Such an identification is for example performed in accordance with what is described in International Patent Application WO2018/130982, incorporated herein for reference.

The control unit 5 is configured to emit, as a function of the second input signal I2 and the identified operating condition, a driving signal P structured to drive the electrical device 4 and the central electric motor 3 so that the state of charge SOC of the battery pack 2 follows a defined reference state of charge.

Preferably the electrical device 4 is an electric hub motor 4a arranged at the hub of one of the wheels, preferably of the front wheel 102a. The electric hub motor 4a is selectively drivable according to a first driving mode, in which it operates as an actuator to provide a torque to the respective wheel, and according to a second driving mode, in which it operates as an electric generator to transfer current to the battery pack 2 as indicated above.

previous,

In this case, the control unit 5 is configured to emit a driving signal P structured so as to drive the electrical device motor 4, selecting the first driving mode when the bicycle is in the servo operating condition and selecting the second driving mode when the bicycle is in the charging operating condition.

In the first driving mode, the control unit 5 is preferably configured to emit a driving signal structured so as to drive the central electric motor 3 and the electrical device 4 so as to combine the contributions thereof as a function of the linear speed of the bicycle V_{bike} and the transmission ratio K of the bicycle. The transmission ratio K can be calculated as ω_{mid}/ω_{hub} i.e., as the ratio between the angular speed of the central electric motor 3 and the angular speed of the electrical device 4.

Preferably, the central electric motor 3 and the electrical device 4 are configured to respectively provide a first and a second torque contribution, in which in the first driving mode of the electrical device 4 the control unit 5 is configured to modulate said first and second torque contribution as a function of the linear speed V_{bike} of the bicycle and the transmission ratio K of the bicycle.

In use, the control of a pedal-assisted bicycle made according to at least one of the embodiments described above includes detecting one or more representative quantities of an operating condition of the bicycle, for example one or more of the pedal speed ω_{ped}, the torque applied to the pedal assembly T_{ped}, the linear speed of the bicycle V_{bike} and a cyclist command (pedal backward, remote control, brake activation).

Furthermore, it is envisaged to detect a value representative of the state of charge (SOC) of the battery pack 2 and to drive the electrical device 4 and the central electric motor 3 as a function of the identified operating condition and the state of charge of the battery pack so that the state of charge of the battery pack 2 follows a defined reference state of charge.

In particular in the case in which the electrical device 4 is obtained by means of an electric motor 4a, the bicycle control includes driving the electric motor by selecting the first driving mode when the bicycle is in the servo operating condition or by selecting the second driving mode when the bicycle is in the charging operating condition (FIG. 5).

With reference to FIGS. 3 and 4, in the first driving mode the central electric motor 3 and the electrical device 4 are preferably driven so as to combine the contributions thereof as a function of the linear speed of the bicycle V_{bike} and the transmission ratio K of the bicycle.

FIG. 3 illustrates a graph showing, as a function of the linear speed V_{bike} of the bicycle, the efficiency of the central electric motor 3 indicated as η_{mid} and the efficiency of the electrical device 4 indicated as η_{hub}. The efficiency η_{hub} of the electrical device 4 (i.e., of the electric motor 4a) is not affected by the transmission ratio K=ω_{mid}/ω_{hub} while the efficiency η_{mid} is affected by the transmission ratio K=ω_{mid}/ω_{hub}.

The graph in FIG. 3 shows that the electrical device 4 is more efficient than the central electric motor 3 in two conditions: at high speeds or at low speeds if K<1. Instead in the case of low speeds and K>1, the central electric motor 3 is more efficient than the electrical device 4 (i.e., the electric motor 4a). It follows that, when the bicycle is in the servo operating condition and the electrical device 4 is driven according to the first driving mode, it is possible to obtain a variable combination of the two motors as a function of the transmission ratio and the linear speed. Such combination possibilities are shown in FIG. 4 in the case of low linear speeds and envisage a greater contribution of the electrical device 4 if K<1 and a greater contribution of the central electric motor 3 if K>1.

With reference to FIG. 3, in the case in which the electrical device 4 is an electric hub motor 4a, in the servo operating condition it is possible to drive the electric hub motor 4a and the central electric motor 3, maximizing the overall efficiency of the system, in certain embodiments also independently of assessments related to the state of charge of the battery pack 3.

For example, such maximum efficiency can be obtained by following a maximum efficiency curve resulting from an envelope of the efficiency curves of the electric hub motor 4a and the central electric motor 3 as a function of the linear speed V_{bike} of the bicycle and the transmission ratio K of the bicycle.

In this case, regardless of the charging modes, one or more representative quantities of an operating condition of the bicycle are detected to identify the servo operating condition.

In this case, the control unit 5 is configured to receive the plurality of first input signals I1, identify the operating condition of the bicycle as a function of the first input signals I1 and, in the servo operating condition, emit a driving signal P structured to drive the electric hub motor 4a and the central electric motor 3 following the maximum efficiency curve defined above.

1. Pedal-assisted bicycle comprising:
a frame,
at least two wheels each provided with a relative hub,
a pedal assembly,
a transmission operatively interposed between said pedal assembly and one of said wheels,
a traction system comprising:
at least one battery pack,
a central electric motor,
an electrical device configured to operate as an electric generator and a control unit configured to control said electrical device and said central electric motor and to manage the charge level of said battery pack,
wherein said central electric motor is directly connected to the pedal assembly to provide a torque to the pedal assembly itself and is operatively connected to the battery pack to be powered by the battery pack itself, wherein said electrical device is arranged at a hub of a wheel of said wheels and is operatively connected to the battery pack to transfer current to the said battery pack,
wherein said control unit is configured to receive a plurality of first input signals representative of an operating condition of the bicycle selectively variable between a servo operating condition and a charging operating condition,
wherein said control unit is configured to receive a second input signal representative of the state of charge of the battery pack, and
wherein said control unit is configured to:
identify the operating condition of the bicycle as a function of the first input signals and
emit, according to the second input signal and the identified operating condition, a driving signal structured to drive the electrical device, operating as an electric generator, so as to increase the charge level of the battery pack.

2. Pedal-assisted bicycle according to claim 1, wherein the driving signal is structured to drive the electrical device so that the state of charge of the battery pack follows a defined reference state of charge.

3. Pedal-assisted bicycle according to claim 1, wherein said first input signals comprise one or more of:
a first input signal representative of the pedal speed (ω_{ped}),
a first input signal representative of the torque applied to the pedal assembly (T_{ped}),
a first input signal representative of the linear speed of the bicycle (V_{bike}).

4. Pedal-assisted bicycle according to claim 1, wherein said traction system comprises first sensor means and second sensor means, operatively connected to the control unit, wherein said first sensor means are configured to detect one or more quantities representative of the operating condition of the bicycle and to generate a respective first input signal and wherein said second sensor means are configured to detect a value representative of the state of charge of the battery pack and to generate said second input signal.

5. Pedal-assisted bicycle according to claim 4, wherein said first sensor means comprise one or more of:
a first sensor configured to detect a representative amount of pedal speed (ω_{ped}) and/or torque applied to the pedal assembly (T_{ped}),
a second sensor configured to detect a representative amount of the linear speed (V_{bike}) of the bicycle.

6. Pedal-assisted bicycle according to claim 1,
wherein said electrical device is an electric hub motor selectively drivable according to a first driving mode, in which it operates as an actuator to provide a torque to the respective wheel, and according to a second driving mode, in which it operates as an electric generator to transfer an electric current to the battery pack, and
wherein said control unit is configured to modulate the driving signal so as to drive the electrical device in said first driving mode when the bicycle is in the servo operating condition and in said second driving mode when the bicycle is in the charging operating condition.

7. Pedal-assisted bicycle according to claim 6, wherein said central electric motor and said electrical device are configured to respectively provide a first and a second torque contribution, wherein in the first driving mode of the electrical device the control unit is configured to modulate said first and second torque contributions according to the linear speed (V_{bike}) of the bicycle and the transmission ratio of the bicycle.

8. Method for controlling a pedal-assisted bicycle comprising:
providing a pedal-assisted bicycle according to claim 1,
detecting one or more quantities representative of a bicycle operating condition, wherein said operating condition is selectively variable between a servo operating condition and a charging operating condition,
detecting a value representative of the state of charge of the battery pack,
identifying the operating condition of the bicycle and driving the electrical device operating as a generator as a function of the identified operating condition and the state of charge of the battery pack so as to increase the charge level of the battery pack.

9. Method for controlling a pedal-assisted bicycle according to claim 8, wherein the electrical device is driven so that the state of charge of the battery pack follows a defined reference state of charge.

10. Method for controlling a pedal-assisted bicycle according to claim 8, comprising detecting as quantities representative of an operating condition of the bicycle one or more of:
the pedal speed (ω_{ped})
the torque applied to the pedal assembly (T_{ped}),
the linear speed (V_{bike}) of the bicycle.

11. Method for controlling a pedal-assisted bicycle according to claim 8, comprising:
providing a pedal-assisted bicycle,
driving the electrical device in said first driving mode when the bicycle is in the servo operating condition or in said second driving mode when the bicycle is in the charging operating condition.

12. Method for controlling a pedal-assisted bicycle according to claim 11, wherein said central electric motor and said electrical device respectively provide a first and a second torque contribution and wherein, in the first driving mode of the electrical device, said first and second torque contributions are modulated as a function of the linear speed (V_{bike}) of the bicycle and the transmission ratio of the bicycle.
